(19) United States
(12) Patent Application Publication
(10) Pub. No.: US 2023/0036122 A1
(43) Pub. Date: Feb. 2, 2023

(54) VALVE ASSEMBLY FOR A FUEL TANK

(71) Applicant: EATON INTELLIGENT POWER LIMITED, DUBLIN (IE)

(72) Inventors: Anuj Kankaria, Pune (IN); Mayur Pote, Latur (IN); Ruchi Vyas, Pune (IN)

(21) Appl. No.: 17/871,789

(22) Filed: Jul. 22, 2022

(30) Foreign Application Priority Data
Jul. 27, 2021 (IN) 202111033673

(51) Int. Cl. F16K 31/22

(52) U.S. Cl. CPC F16K 31/22

(57) ABSTRACT

A valve assembly includes a valve housing, a cap coupled to the valve housing and defining a cap inlet, a float movably disposed inside the valve housing such that the float is movable relative to the valve housing, a ribbon coupled between the float and the cap such that the ribbon is movable relative to the valve housing upon movement of the float. The float includes a main float body and a retaining feature coupled to the main float body, and the retaining feature secures the ribbon attached to the float.

### INTRODUCTION

The present disclosure relates to a valve assembly for a fuel tank.

### BACKGROUND

Fuel tank valves can function to vent vapors from a fuel tank. Generally, the vapors are vented to a canister that stores the vapors and is periodically purged. Fuel tank valves are configured to prevent liquid fuel in the fuel tank from entering the canister when the vehicle is parked on a grade.

### SUMMARY

The present disclosure relates to a valve assembly in which a ribbon is directly connected to the float without the aid of fasteners. For instance, no clip is necessary to couple the ribbon to the float or the valve housing of the valve assembly.

In an aspect of the present disclosure, the valve assembly includes a valve housing, a cap coupled to the valve housing and defining a cap inlet, a float movably disposed inside the valve housing such that the float is movable relative to the valve housing, a ribbon coupled between the float and the cap such that the ribbon is movable relative to the valve housing upon movement of the float. The float includes a main float body and a retaining feature coupled to the main float body, and the retaining feature maintains the ribbon attached to the float.

In an aspect of the present disclosure, the ribbon is movable relative to the valve housing between a first ribbon position and a second ribbon position. Further, the ribbon is spaced apart from the cap inlet of the cap to allow fluid flow through the cap inlet in the first ribbon position. The ribbon seals the cap inlet of the cap to preclude fluid from exiting the valve housing through the cap in the second ribbon position. The valve assembly is characterized by an absence of a clip coupling the ribbon to the float. The retaining feature is integrally coupled to the main float body such that the main float body and the retaining feature are part of a unitary one-piece structure. The ribbon is directly coupled to the float, and the ribbon is directly coupled to the valve housing.

In an aspect of the present disclosure, the float is movable relative to the valve housing along a first direction. The retaining feature includes a first pin that is elongated along the first direction. The ribbon includes a first end portion and a second end portion opposite the first end portion. The ribbon defines a slot extending through the first end portion. The slot receives the first pin to couple the ribbon to the float.

In an aspect of the present disclosure, the float includes a retaining protrusion extending directly from the first pin along a second direction. The second direction is perpendicular to the first direction. The first end portion of the ribbon rests directly on the retaining protrusion maintaining the ribbon coupled to the float.

In an aspect of the present disclosure, the float includes a flange extending from the main float body in the second direction. The float further includes a first sidewall and a second sidewall each coupled to the flange, the first sidewall, the second sidewall, and the first pin are parallel to one another. The retaining feature further includes a first beam extending directly from the first sidewall along a third direction. The third direction is perpendicular to the first direction and the second direction. The retaining feature further includes a second beam extending directly from the second sidewall in the third direction. Each of the first beam and the second beam are spaced apart from the first pin. The first end portion of the ribbon rests on the first beam and the second beam maintains the ribbon coupled to the float.

The float is movable relative to the valve housing along a first direction. The retaining feature includes a first pin that is elongated along the first direction. The ribbon includes a first end portion and a second end portion opposite the first end portion. The ribbon defines a slot extending through the first end portion. The slot receives the first pin to couple the ribbon to the float. The retaining feature further includes a barb integrally coupled to the first pin such that the barb and the first pin are part of a unitary one-piece structure. The barb has a tapered shape such that a width of the barb continuously increases in a second direction. The second direction is perpendicular to the first direction, the retaining feature further includes a first rib coupled to the main float body and a second rib coupled to the main float body. The first rib and the second rib are parallel to each other. The first pin and the barb are disposed between the first rib and the second rib. The float further includes a flange extending from the main float body. The flange is directly coupled to the first pin. The flange is coupled between the first rib and the second rib.

The float is movable relative to the valve housing along a first direction. The retaining feature includes a first pin that is elongated along the first direction. The ribbon includes a first end portion and a second end portion opposite the first end portion. The ribbon defines a slot extending through the first end portion. The slot receives the first pin to couple the ribbon to the float, the retaining feature further includes a first rib coupled to the main float body and a second rib coupled to the main float body. The first rib and the second rib are parallel to each other. The first pin is disposed between the first rib and the second rib. The float further includes a flange extending from the main float body in a second direction. The second direction is perpendicular to the first direction. The flange is directly coupled to the first pin, and the flange is coupled between the first rib and the second rib. The first pin has a first side and a second side opposite the first side. The retaining feature further includes a first projection extending directly from first side of the first pin along a third direction. The third direction is perpendicular to the first direction and the second direction. The retaining feature further includes a second projection extending directly from the second side of the first pin along the third direction. The first projection and the second projection are disposed below the first rib and the second rib. The first end portion of the ribbon rests on the first projection and the second projection to maintain the ribbon coupled to the float.

In an aspect of the present disclosure, the float is movable relative to the valve housing along a first direction. The retaining feature includes a first pin that is elongated along the first direction. The ribbon includes a first end portion and a second end portion opposite the first end portion. The ribbon defines a slot extending through the first end portion. The slot receives the first pin to couple the ribbon to the float. The slot has an oval shape. The first pin has a main pin portion. The main pin portion has a cross-section an oval shape that matches the oval shape of the slot. The first pin has a pin end portion. The pin end portion has a tapered shape. The pin end portion has an end cross-section with a circular shape. The first pin has a first side and a second side opposite the first side. The first pin includes a first wing extending from the first side and a second wing extending from the second wing.

In an aspect of the present disclosure, the float is movable relative to the valve housing along a first direction. The retaining feature includes a second pin that is elongated along a second direction. The second direction is perpendicular to the first direction. The ribbon includes a first end portion and a second end portion opposite the first end portion. The ribbon defines a slot extending through the first end portion. The slot receives the second pin to couple the ribbon to the float. The float defines a recess, and the second pin is disposed within the recess. The horizontal pin is integrally coupled to the float such that the second pin and the float are part of a unitary one-piece structure.

In an aspect of the present disclosure, the second pin has an oval shape.

In an aspect of the present disclosure, the second pin has a circular shape.

In an aspect of the present disclosure, the second pin has at least one wing to help retain the ribbon.

In an aspect of the present disclosure, the float is movable relative to the valve housing along a first direction. The retaining feature includes a second pin that is elongated along a second direction. The second direction is perpendicular to the first direction. The ribbon includes a first end portion and a second end portion opposite the first end portion. The ribbon defines a slot extending through the first end portion. The slot receives the second pin to couple the ribbon to the float. The float defines a pocket. The second pin is entirely disposed within the pocket. The horizontal pin is integrally coupled to the float such that the second pin and the float are part of a unitary one-piece structure. The second pin includes a mechanical stop extending radially outward from an end of the second pin to retain the ribbon to the float.

In an aspect of the present disclosure, the float further contains a hole.

The present disclosure also describes a fuel tank assembly. The fuel tank assembly includes a fuel tank and a valve assembly as described above. The valve assembly is coupled to the fuel tank.

The present disclosure also describes a method of coupling a ribbon to a float of a valve assembly. In an aspect of the present disclosure, the method includes: moving a ribbon towards a float until a slot of a first end portion of the ribbon engages a retaining feature of the float; and bending a second end portion of the ribbon to over the float in order to facilitate assembly with a valve housing of the valve assembly.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic partial cross-sectional side illustration of a valve assembly mounted to a fuel tank, with a vapor control structure (e.g., a canister) cooperating with the valve assembly.

FIG. 2 is a schematic isometric view of the valve assembly shown in FIG. 1.

FIG. 3 is a schematic top, isometric, view of the valve assembly of FIG. 2.

FIG. 4 is a schematic cross-sectional side view of the valve assembly of FIG. 2.

FIG. 5 is a schematic top view of a ribbon of the valve assembly of FIG. 2.

FIG. 6 is a schematic front view of a float of the valve assembly of FIG. 2.

FIG. 7 is a schematic rear view of the float of FIG. 6.

FIG. 8 is a schematic, fragmentary, enlarged front view of an area of the float of FIG. 6.

FIG. 9 is a schematic, fragmentary, isometric front view of the float of FIG. 6 while a ribbon is being coupled to the float.

FIG. 10 is a schematic, fragmentary, isometric front view of the float of FIG. 6 while the ribbon is being coupled to the float of FIG. 6.

FIG. 11 is a schematic, fragmentary, isometric front view of the float of FIG. 6 after the ribbon is bent over the float of FIG. 6.

FIG. 12 is a schematic isometric view of a first slider and a second slider being withdrawn from the float of FIG. 6.

FIG. 13 is a schematic, fragmentary, isometric top view of the first slider attached to the float of FIG. 6.

FIG. 14 is a schematic isometric bottom view of the first slider attached to the float of FIG. 6.

FIG. 15 is a schematic isometric top view of the second slider attached to the float of FIG. 6.

FIG. 16 is a schematic isometric view of the first slider of FIG. 12.

FIG. 17 is a schematic isometric top view of the second slider of FIG. 12.

FIG. 18 is a schematic isometric side view of the second slider of FIG. 12.

FIG. 19 is a schematic, fragmentary, front view of part of a float in accordance with another aspect of the present disclosure.

FIG. 20 is a schematic, fragmentary, front view of part of the float of FIG. 19 with a ribbon being coupled to the float.

FIG. 21 is a schematic, fragmentary, front view of part of the float of FIG. 19 with the ribbon coupled to the float.

FIG. 22 is a schematic, fragmentary, front view of part of the float of FIG. 19 with the ribbon being bent over the float.

FIG. 23 is a schematic isometric view of a first slider and a second slider being withdrawn from the float of FIG. 19.

FIG. 24 is a schematic isometric side view of the first slider attached to the float of FIG. 19.

FIG. 25 is a schematic, fragmentary, isometric bottom view of the first slider attached to the float of FIG. 19.

FIG. 26 is a schematic, fragmentary isometric top view of the second slider attached to the float of FIG. 19.

FIG. 27 is a schematic isometric bottom view of the first slider of FIG. 23.

FIG. 28 is a schematic isometric top view of the second slider of FIG. 23.

FIG. 29 is a schematic isometric side view of the second slider of FIG. 23.

FIG. 30 is a schematic isometric view of a float in accordance with an aspect of the present disclosure.

FIG. 31 is a schematic, fragmentary, isometric enlarged view of part of the float of FIG. 30.

FIG. 32 is a schematic, fragmentary isometric view of a first step of a process of attaching the ribbon to the float of FIG. 30.

FIG. 33 is a schematic, fragmentary, isometric view of a second step of a process of attaching the ribbon to the float of FIG. 30.

FIG. 34 is a schematic isometric view of a first slider and a second slider being withdrawn from the float of FIG. 30.

FIG. 35 is a schematic isometric top view of the first slider being attached to the float of FIG. 30.

FIG. 36 is a schematic isometric bottom view of the first slider attached to the float of FIG. 30.

FIG. 37 is a schematic isometric view of the first slider of FIG. 34.

FIG. 38 is a schematic, fragmentary, isometric top view of the second slider attached to the float of FIG. 30.

FIG. 39 is a schematic, fragmentary, isometric rear view of the second slider of FIG. 34 attached to the float of FIG. 30.

FIG. 40 is a schematic, fragmentary, isometric side view of the second slider of FIG. 34.

FIG. 41 is a schematic isometric enlarged view of part of a float in accordance with an aspect of the present disclosure.

FIG. 42 is a schematic isometric cross-sectional view of part of the float of FIG. 41.

FIG. 43 is a schematic isometric view of part of the float of FIG. 41.

FIG. 44 is a schematic top view of a ribbon for use with the float of FIG. 41.

FIG. 45 is a schematic enlarged view of part of the ribbon of FIG. 44.

FIG. 46 is a schematic, fragmentary, isometric front view of the float of FIG. 30 while the ribbon is coupled to the float.

FIG. 47 is a schematic, fragmentary, isometric front view of the float of FIG. 30 after the ribbon is bent over the float.

FIG. 48 is a schematic isometric view of a first slider and a second slider being withdrawn from the float of FIG. 43.

FIG. 49 is a schematic isometric top view of the first slider attached to the float of FIG. 43.

FIG. 50 is a schematic, fragmentary isometric bottom view of the first slider attached to the float of FIG. 43.

FIG. 51 is a schematic isometric top view of the second slider attached to the float of FIG. 43.

FIG. 52 is a schematic isometric view of the first slider of FIG. 48.

FIG. 53 is a schematic, fragmentary, isometric front view of the second slider of FIG. 48.

FIG. 54 is a schematic isometric rear view of the second slider of FIG. 48.

FIG. 55 is a schematic isometric view of a float in accordance with an aspect of the present disclosure.

FIG. 56 is a schematic, fragmentary, isometric view of part of the float of FIG. 55.

FIG. 57 is a schematic, fragmentary, isometric view of the ribbon moving toward the float of FIG. 48 to attach the ribbon to the float.

FIG. 58 is a schematic, fragmentary, isometric view of the ribbon being attached to the float of FIG. 48.

FIG. 59 is a schematic, fragmentary, isometric view of the ribbon being bent over the float of FIG. 48.

FIG. 60 is a schematic, fragmentary, isometric view of part of a float according to an aspect of the present disclosure.

FIG. 61 is a schematic, fragmentary, isometric view of part of a float in accordance with another aspect of the present disclosure.

FIG. 62 is a schematic, fragmentary, isometric view of part of a float in accordance with another aspect of the present disclosure.

FIG. 63 is a schematic, fragmentary cross-sectional side view of part of the float of FIG. 62.

FIG. 64 is a schematic, fragmentary, isometric view of part of a float in accordance with an aspect of the present disclosure.

FIG. 65 is a schematic, fragmentary, isometric view of part of a float in accordance with an aspect of the present disclosure.

FIG. 66 is a schematic isometric view of part of a float in accordance with another aspect of the present disclosure with a hole.

### DETAILED DESCRIPTION

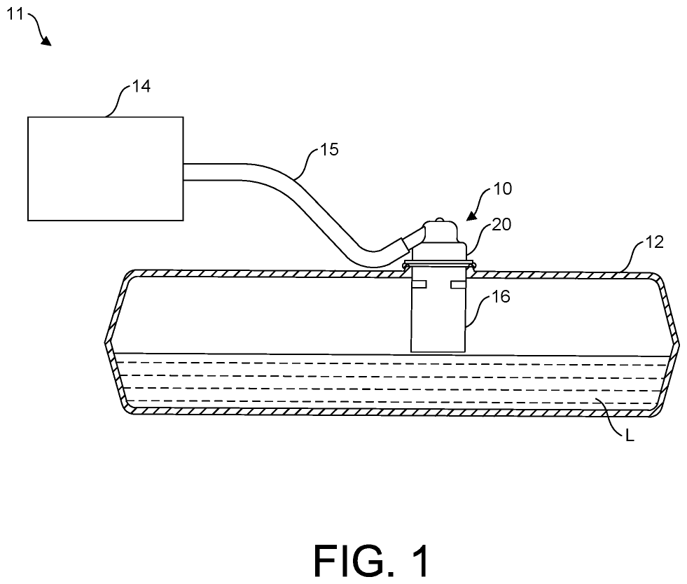

Referring to the drawings, wherein like reference numbers correspond to like or similar components throughout the several figures, a valve assembly 10 for a tank 12 is generally shown in FIG. 1. In certain embodiments, the tank 12 may be a fuel tank of a vehicle. Therefore, liquid fluid L, such as liquid fuel, can be stored in the tank 12. The valve assembly 10 can be utilized with tanks 12 other than fuel tanks. For example, the valve assembly 10 may be mounted to a urea tank in a vehicle. Therefore, other liquids can be stored in the tank 12. The valve assembly 10 is coupled to the tank 12. For instance, as shown in FIG. 1, a portion of the valve assembly 10 is disposed inside the tank 12, and another portion of the valve assembly 10 is disposed outside the tank 12. The valve assembly 10 includes a cover 20 directly coupled to the valve housing 16 and coupled to the tank 12 such as by fusion or adhesive. During operation, the valve assembly 10 allows vapor that builds up in the tank 12 to be vented out of the tank 12 to a vapor control structure 14. The vapor control structure 14 can store the vapor received from the tank and can be periodically purged. Therefore, under certain conditions, the vapors flow from the tank 12 through the valve assembly 10 and into the vapor control structure 14 through a fluid conduit 15. The fluid conduit 15 is coupled to the valve assembly 10 through the cover 20. The fluid conduit 15 may be, for example, a hose and can establish fluid communication between the vapor control structure 14 and the valve assembly 10. The vapor control structure 14 may be a canister, such as a charcoal canister. The vapor control structure 14, the valve assembly 10, and the tank 12 are collectively referred to as a tank assembly 11 (e.g., the fuel tank assembly).

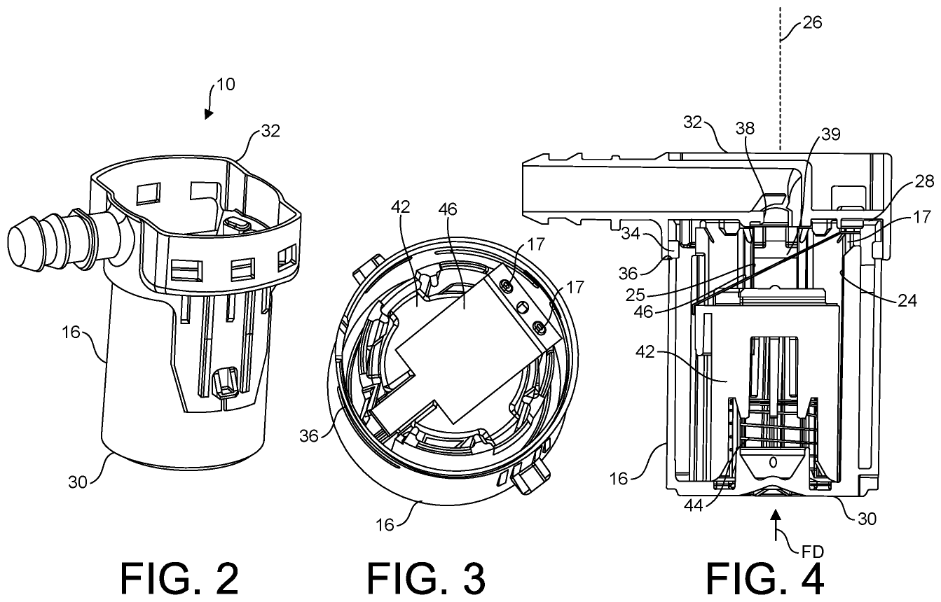

With reference to FIGS. 2, 3, and 4, the valve assembly 10 includes a valve housing 16 (which may be alternatively referred to as a valve body). The valve housing 16 is hollow and therefore defines a housing cavity 24 along a longitudinal axis 26. In the depicted embodiment, the valve housing 16 is elongated along the longitudinal axis 26 and has a cylindrical shape to faciliate manufacturing. It is contemplated, however, that the valve housing 16 may have other suitable shapes. Regardless of its shape, the valve housing 16 defines one or more housing inlets 25 to allow fluid flow into the valve housing 16. In the depicted embodiment, the housing inlets 25 are configured as holes extending through the valve housing 16 to allow the liquid L to flow from the tank 12 into the housing cavity 24 of the valve housing 16. The valve assembly 10 further includes a cap 32 coupled to the valve housing 16. In the depicted embodiment, one or more snap-fit fasteners may directly couple the cap 32 to the valve housing 16. For instance, the cap 32 may include a snap-fit protrusion 34 configured to be received by a single snap-fit aperture 36 of the valve housing 16. The valve housing 16 defines a single snap-fit aperture 36 to facilitate manufacturing. The cap 32 defines a cap outlet 38 to allow vapors to exit the valve assembly 10. An O-ring may be disposed around the cap outlet 38 to minimize leaks when the cover 20 is secured to the cap 32. The cap 32 further includes a cap inlet 39 configured to receive the vapors inside the valve housing 16. Accordingly, the vapors inside the valve housing 16 can flow through the cap inlet 39, through the cap 32, and out of the cap outlet 38 exiting the valve assembly 10.

With continued reference to FIGS. 2, 3, and 4, The valve assembly 10 further includes a float 42 movably disposed inside the valve housing 16. The float 42 includes a top housing wall 28 and a bottom housing wall 30. During operation, the float 42 moves upwardly along the longitudinal axis 26 as the liquid L flows into the housing cavity 24 of the valve housing 16. The valve assembly 10 further includes a biasing member 44, such as a coil spring, coupled between the valve housing 16 and the float 42 to bias the float 42 upwardly away from the bottom housing wall 30.

With continued reference to FIGS. 2, 3, and 4, the valve assembly 10 further includes a ribbon 46 directly coupled to the valve housing 16. As such, the ribbon 46 can move in unison with the float 42. The float 42 includes a retaining feature 48 (FIG. 8) between the top housing wall 28 and the bottom housing wall 30. The ribbon 46 is coupled to the valve housing 16. The ribbon 46 can move in unison with the float 42 between a first ribbon position (FIG. 4) and a second ribbon position. In the second ribbon position, the ribbon 46 seals the cap inlet 39 (and consequently the cap outlet 38) of the cap 32 to preclude fluid from exiting the valve housing 16 through the cap outlet 38 of the cap 32. In the first ribbon position, the ribbon 46 is spaced apart from the cap inlet 39 (and also the cap outlet 38) of the cap 32 to allow fluid flow through the cap inlet 39 and the cap outlet 38, thereby allow vapors to exit the valve assembly 10. The longitudinal axis 26 extends through the cap outlet 38 and the cap inlet 39 of the cap 32. During operation, as the liquid fluid L flows into the housing cavity 24 of the valve housing 16, the float 42 moves upwardly along a first direction FD from a first float position (FIG. 3) and a second float position. The first direction FD may alternatively be referred to as the vertical direction. As discussed above, the ribbon 46 moves simultaneously with the float 42. Accordingly, as the float 42 moves from the first float position to the second float position, the ribbon 46 moves from the first ribbon position (FIG. 3) to the second ribbon position. In the second ribbon position, the ribbon 46 seals the cap inlet 39 (and therefore the cap outlet 38) of the cap 32 to preclude fluid from exiting the valve assembly 10 through the cap outlet 38 of the cap 32. Specifically, in the second ribbon position, the ribbon 46 directly contacts (i.e., abuts) the cap inlet 39, thereby sealing the cap inlet 39 and the cap outlet 38. As a consequence, fluid flow is precluded from exiting the valve assembly 10 through the cap 32. During the movement between the first ribbon position and the second ribbon position, the float 42 causes the ribbon 46 to be bent in order to completely and hermetically seal the cap inlet 39, thereby preventing the liquid fluid L from exiting the valve assembly 10 through the cap 32.

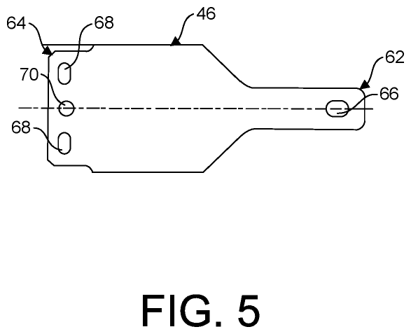

With reference to FIGS. 3 and 5, the ribbon 46 is directly coupled to the valve housing 16. Thus, the valve assembly 10 is characterized by an absence of a clip (or any other fastener) coupling the ribbon 46 to the float 42. In other words, in this embodiment, no clip or other fastener couples the ribbon 46 to the float 42. Rather, the ribbon 46 is directly coupled to the valve housing 16 without the need of fasteners, such as clips, thereby simplying the valve assembly 10. In the depicted embodiment, the ribbon 46 includes a first end portion 62 and a second end portion 64 opposite the first end portion 62. The ribbon defines a first slot 66 extending through the first end portion 62 and one or more second slots 68 extending through the second end portion 64. The ribbon 46 may further includes a thru-hole 70 disposed at the second end portion 64 between the second slots 68. The valve housing 16 includes one or more housing protrusions 17 each sized to be received by the second slots 68 of the ribbon 46. Stated differently, each of the second slots 68 receives a respective one of the housing protrusions 17 to couple the ribbon 46 to the valve housing 16.

With reference FIGS. 5, 6, 7, and 8, the float 42 includes a main float body 47 and retaining feature 48 coupled to the main float body 47. The retaining feature 48 is configured to maintain the ribbon 46 (FIG. 5) coupled to the float 42. In the depicted embodiment, the retaining feature 48 is integrally coupled to the main float body 47 to facilitate manufacturing. As such, the main float body 47 and the retaining feature 48 are part of a unitary, one-piece structure to facilitate manufacturing. In the depicted embodiment, the retaining feature 48 includes a first pin 50 that is elongated along the first direction FD. The first direction FD may alternatively be referred to as the vertical direction. The first pin may be referred to as the vertical pin. The first slot 66 of the ribbon 46 is configured, shaped and sized to receive the first pin 50 to couple the first end portion 62 of the ribbon 46 to the float 42. In other words, the first slot 66 receives the first pin 50 to couple the ribbon 46 to the float 42.

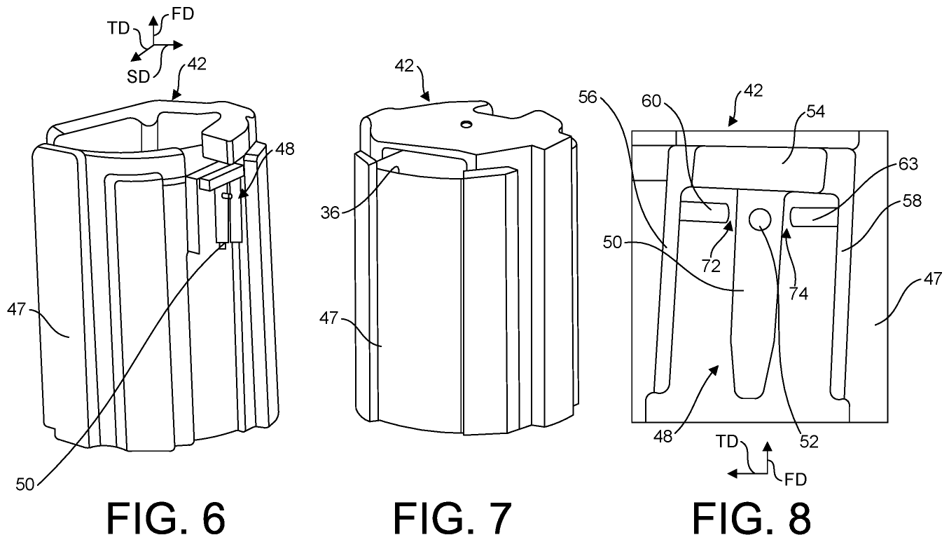

With reference FIGS. 6, 7, and 8, the float 42 includes a retaining protrusion 52 extending directly form the first pin 50 along a second direction SD. The second direction SD is perpendicular to the first direction and may alternatively be referred to as the transverse direction. When the valve assembly 10 is assembled, the first end portion 62 of the ribbon 46 rests directly on the retaining protrusion 52 to maintain the ribbon 46 coupled to the float 42.

With continued reference FIGS. 6, 7, and 8, the float 42 includes a flange 54 extending directly from the main float body 47 in the second direction SD. The float 42 further includes a first sidewall 56 and a second sidewall 58 each coupled to the flange 54. The first sidewall 56 and the second sidewall 58 are each elongated along the second direction SD. The first sidewall 56, the first pin 50, and the second sidewall 58 are parallel to one another. The retaining feature 48 further includes a first beam 60 and a second beam 63. The first beam 60 extends directly from the first sidewall 56 along a third direction TD, and the second beam 63 extends directly from the second sidewall 58 along the third direction TD. The third direction TD is perpendicular to the first direction FD and the second direction SD and may alternatively be referred to as the horizontal direction. Each of the first beam 60 and the second beam 63 is elongated along the third direction TD. The first beam 60 and the second beam 63 are parallel to each other. The first beam 60 is spaced apart from the first pin 50 along the third direction TD to define a first gap 72 between the first beam 60 and the first pin 50. The second beam 63 is spaced apart from the first pin 50 along the third direction TD to define a second gap 74 between the first pin 50 and the second beam 63. The first gap 72 and the second gap 74 allow the first end portion 62 of the ribbon 46 to be placed above the retaining protrusion 52, the first beam 60, and the second beam 63 while the first slot 66 receives the first pin 50. Therefore, the first end portion 62 of the ribbon 46 rests on the first beam 60 and the second beam 63 to help maintain the ribbon 46 coupled to the float 42.

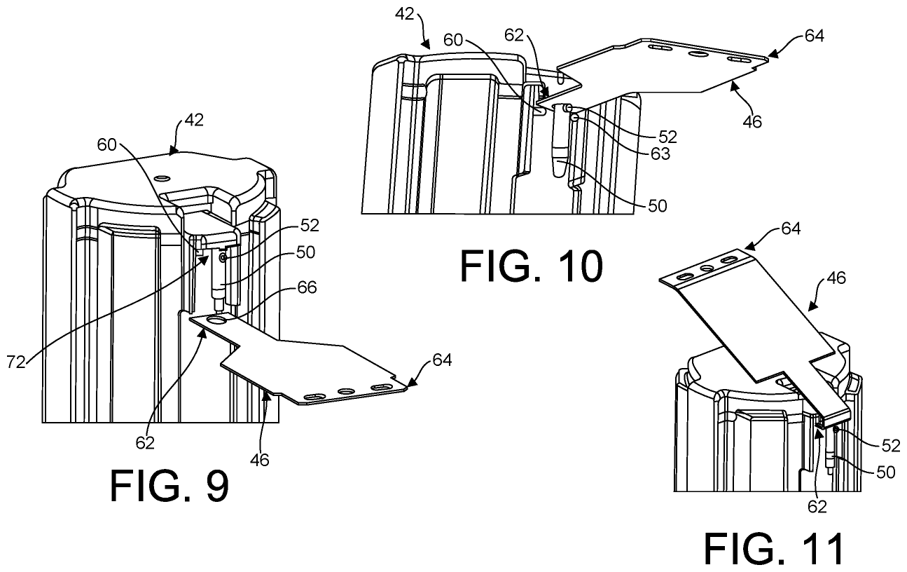

With reference to FIGS. 9, 10, and 11, to couple the ribbon 46 to the float 42, the ribbon 46 is moved toward the float 42 so that the first pin 50 is inserted into the first slot 66 as shown in FIG. 9. Then, the ribbon 46 is moved toward the retaining protrusion 52 and pushed through the first gap 72 and the second gap 74 (FIG. 8) until the first end portion 62 of the ribbon 46 rests on the retaining protrusion 52, the first beam 60, and the second beam 63 as shown in FIG. 10. Next, the ribbon 46 is bent over the float 42 so that the second end portion 64 of the ribbon 46 is positioned above the float 42 as shown in FIG. 11.

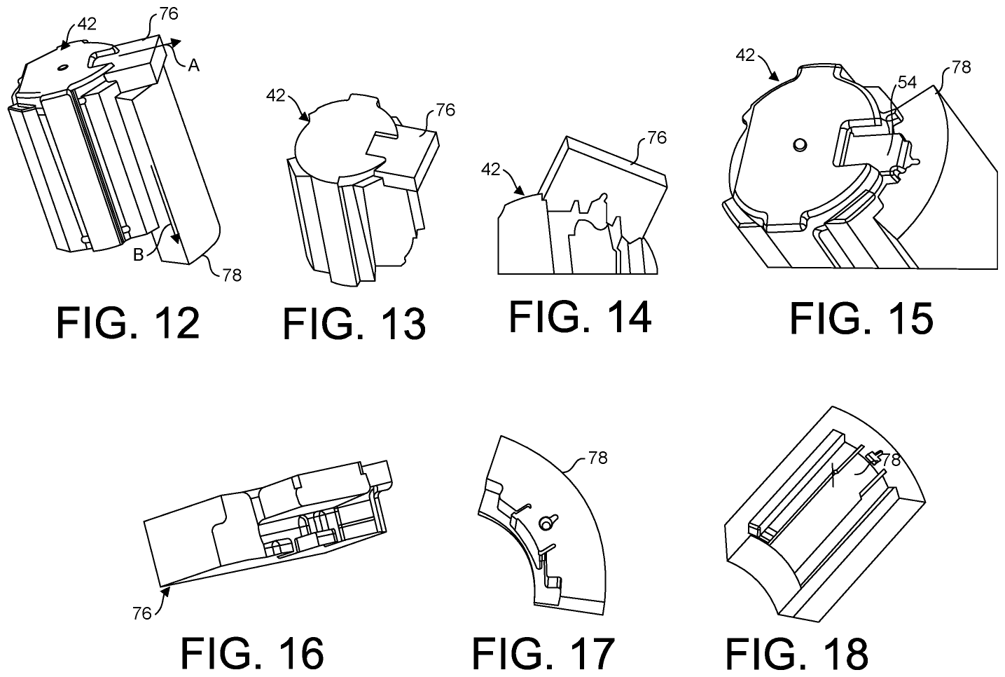

With reference to FIGS. 12-18, to manufacture the float 42, a first slider 76 and a second slider 78 may be used during an injection molding process. The first slider 76. The first slider 76 is shaped to form an area of the float 42 surrounding the flange 54. Accordingly, the first slider 76 has inner cavities that correspond to the shape of the area surrounding the flange 54. The second slider 78 is shaped to form a rear area of the float 42, including the area surrounding the retaining feature 48. Therefore, the second slider 78 includes inner cavities that corresponding to the shape of the rear area of the float 42, including the area surrounding the retaining feature 48. To manufacture the float 42, a polymeric material is injected into a mold. After the float 42 is formed, the first slider 76 is moved away from the float 42 in the direction indicated by arrow A, and the second slider 78 is moved away from the float 42 in the direction indicated by arrow B. Because of the shape of the first slider 76 and the second slider 78, each of the first slider 76 and the second slider 78 can slide away from the float 42.

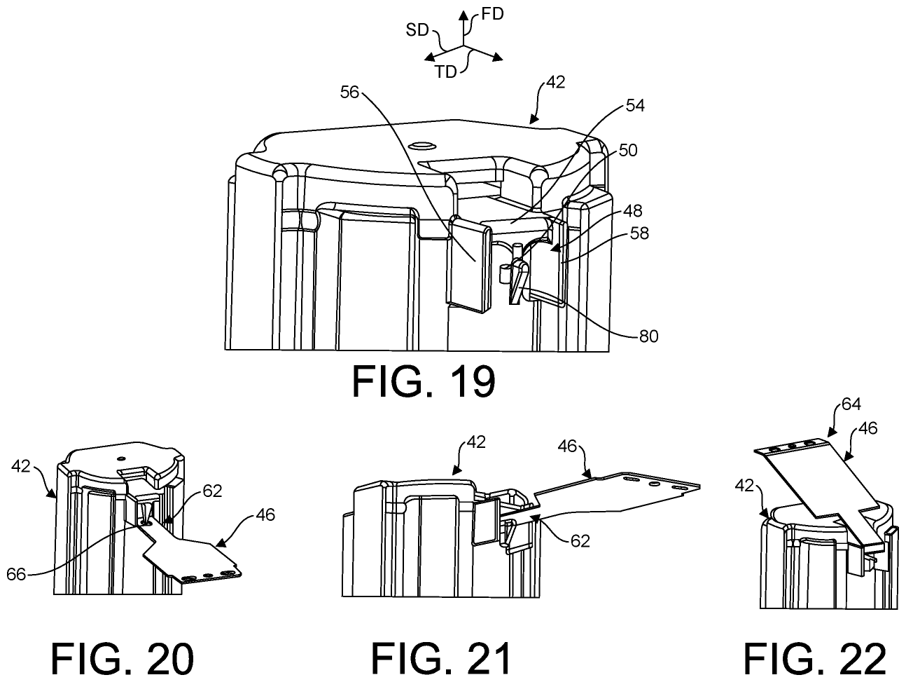

FIG. 19 shows a float 42 in accordance with another aspect of the present disclosure. The structure and operation of the float 42 is substantially similar to the float 42 described above with respect to FIG. 6, except for the features described below. In the depicted embodiment, the first pin 50 of the retaining feature 48 is shorter than the first pin 50 depicted in FIG. 6. Further, first sidewall 56 and the second sidewall 58 may be configured as ribs to prevent the float 42 to minimize movement of the float 42 and protect the first pin 50. Accordingly, the first sidewall 56 may be referred to as the first rib, and the second sidewall 58 may be referred to as the second rib. The retaining feature 48 further includes a barb 80 disposed between the first sidewall 56 and the second sidewall 58. The barb 80 extends directly from the first pin 50 in the third direction TD. Once the ribbon 46 is assembled on the float 42, the first end portion 62 of the ribbon 46 rests directly on the barb 80. Accordingly, the barb 80 helps maintain the ribbon 46 coupled to the float 42. The barb 80 may have a tapered shape to help maintain the ribbon 46 coupled to the float 42. Specifically, the thickness of the barb 80 may continuously decrease in the first direction.

With reference to FIGS. 20, 21, and 22, to couple the ribbon 46 to the float 42 with the barb 80, the ribbon 46 is moved toward the float 42 so that the first pin 50 is inserted into the first slot 66 as shown in FIG. 20. Then, the ribbon 46 is moved toward the barb 80 until the first end portion 62 of the ribbon 46 rests on the barb 80 as shown in FIG. 21. Next, the ribbon 46 is bent over the float 42 so that the second end portion 64 of the ribbon 46 is positioned above the float 42 as shown in FIG. 22.

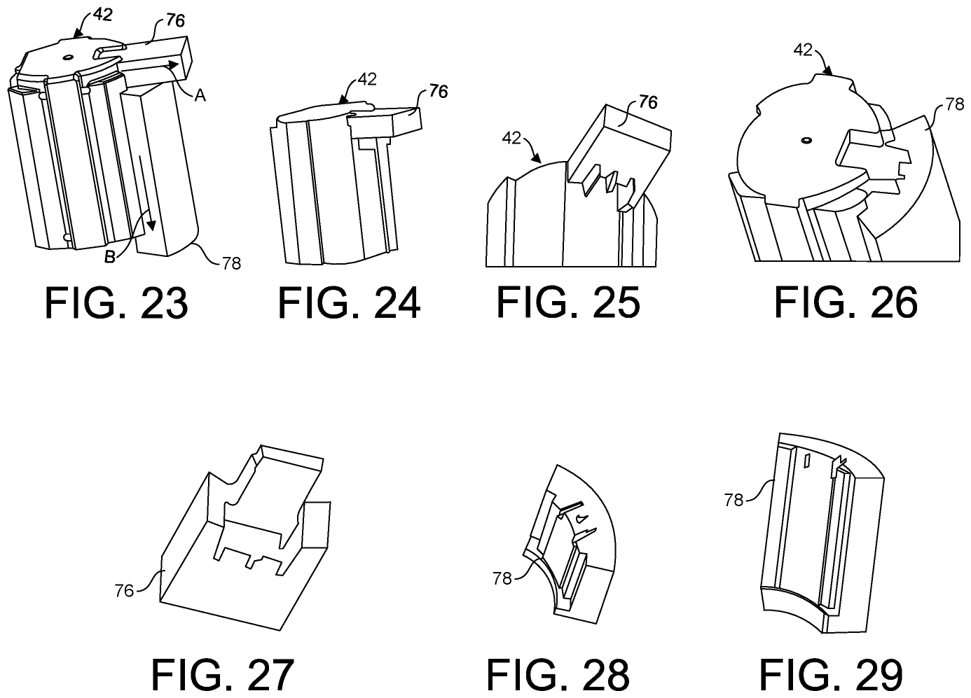

With reference to FIGS. 23-29, to manufacture the float 42 depicted in FIG. 19, a first slider 76 and a second slider 78 may be used during an injection molding process. The first slider 76 is shaped to form an area of the float 42 surrounding the flange 54. Accordingly, the first slider 76 has inner cavities that correspond to the shape of the area surrounding the flange 54. The second slider 78 is shaped to form a rear area of the float 42, including the area surrounding the retaining feature 48. Therefore, the second slider 78 includes inner cavities that corresponding to the shape of the rear area of the float 42, including the area surrounding the retaining feature 48. To manufacture the float 42, a polymeric material is injected into a mold. After the float 42 is formed, the first slider 76 is moved away from the float 42 in the direction indicated by arrow A, and the second slider 78 is moved away from the float 42 in the direction indicated by arrow B. Because of the shape of the first slider 76 and the second slider 78, each of the first slider 76 and the second slider 78 can slide away from the float 42.

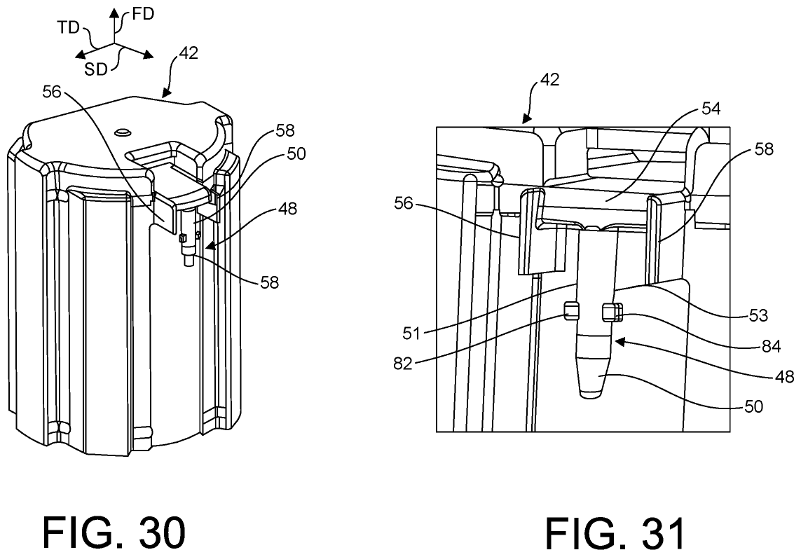

FIGS. 30 and 31 show a float 42 in accordance with another aspect of the present disclosure. The structure and operation of the float 42 is substantially similar to the float 42 described above with respect to FIG. 6, except for the features described below. In the depicted embodiment, the first sidewall 56 and the second sidewall 58 are shorter than in the float shown in FIG. 19 to allow assembly of the ribbon 46 at a ninety degree angle. Further, the first pin 50 is longer than the first sidewall 56 and the second sidewall 58 to allow assembly of the ribbon 46 at a ninety degree angle. The first pin 50 has a first side 51 and a second side 53 opposite the first side 51. The first side 51 of the first pin 50 is spaced apart from the second side 53 along the third direction TD. The retaining feature 48 further includes a first projection 82 and a second projection 84 each extending from the first pin 50 along the third direction TD. The first projection 82 may extend directly from the first side 51 of the first pin 50. The second projection 84 may extend directly from the second side 53 of the first pin 50. The ribbon 46 is configured to rest directly on the first projection 82 and the second projection 84. The retaining feature 48 of this embodiment ensures that the first slot 66 of the ribbon 46 is not stretched (or broken) during assembly.

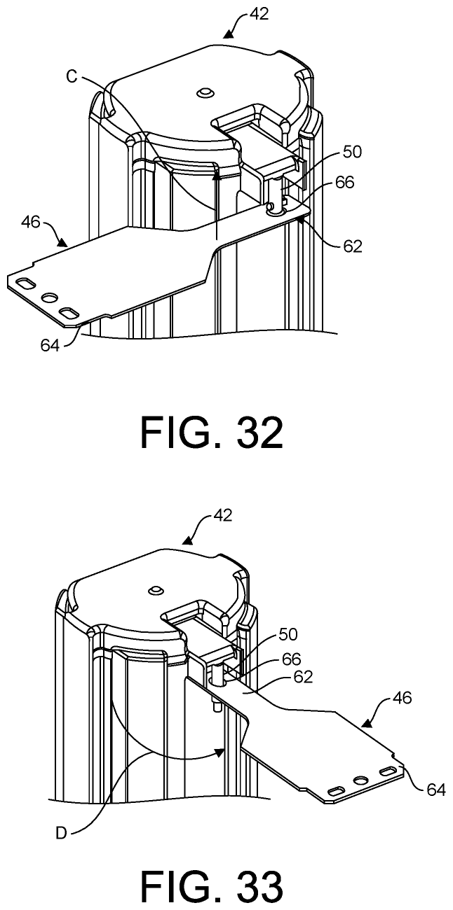

With reference to FIGS. 32 and 33, to couple the ribbon 46 to the float 42 with the first projection 82 and the second projection 84, the ribbon 46 is moved toward the float 42 (in the direction indicated by arrow C) so that the first pin 50 is inserted into the first slot 66 at a ninety degree angle as shown in FIG. 32. Then, the ribbon 46 is moved toward the first projection 82 and the second projection 84 until the first end portion 62 of the ribbon 46 rests on the first projection 82 and the second projection 84 as shown in FIG. 33, thereby coupling the ribbon 46 to the float 42. Next, the ribbon 46 is rotated ninety degrees in the direction indicated by arrow D. Next, the ribbon 46 is bent over the float 42 so that the second end portion 64 of the ribbon 46 is positioned above the float 42.

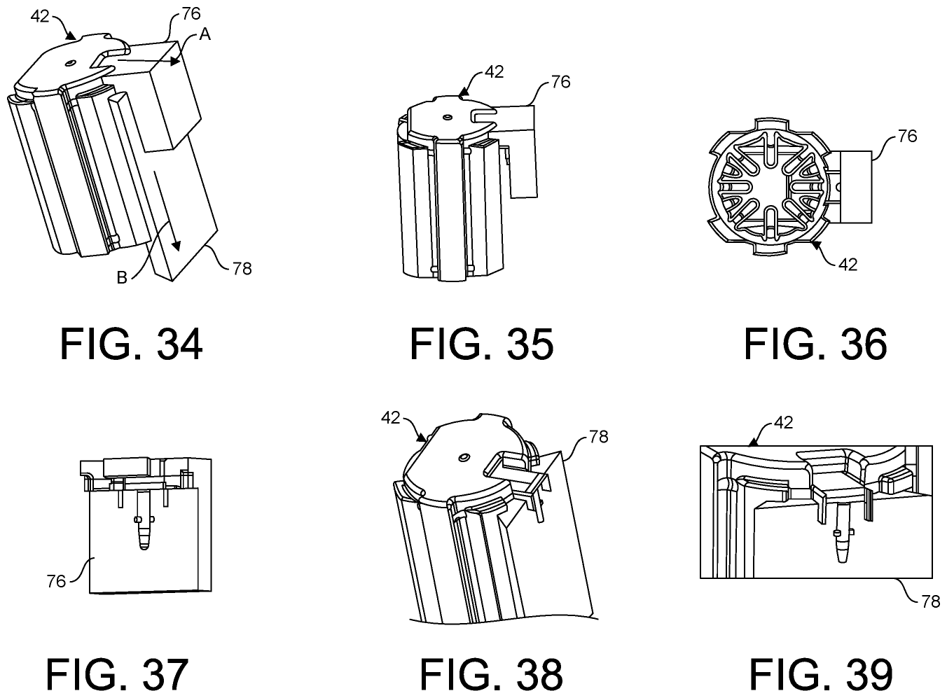

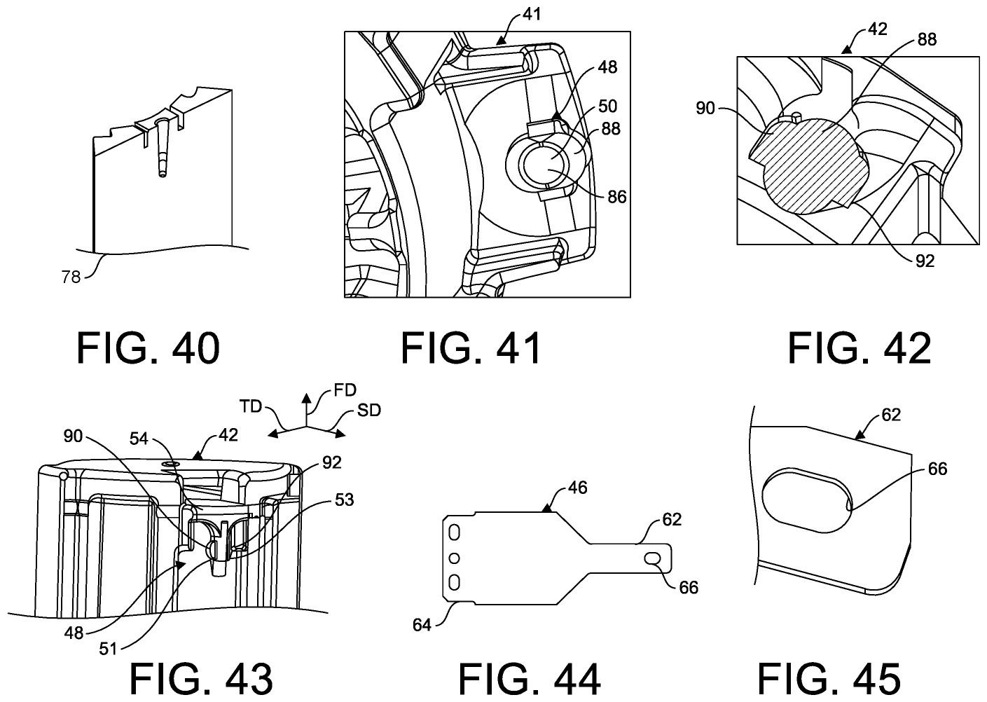

With reference to FIGS. 34-40, to manufacture the float 42 depicted in FIG. 30, a first slider 76 and a second slider 78 may be used during an injection molding process. The first slider 76 is shaped to form an area of the float 42 surrounding the flange 54. Accordingly, the first slider 76 has inner cavities that correspond to the shape of the area surrounding the flange 54. The second slider 78 is shaped to form a rear area of the float 42, including the area surrounding the retaining feature 48. Therefore, the second slider 78 includes inner cavities corresponding to the shape of the rear area of the float 42, including the area surrounding the retaining feature 48. To manufacture the float 42, a polymeric material is injected into a mold. After the float 42 is formed, the first slider 76 is moved away from the float 42 in the direction indicated by arrow A, and the second slider 78 is moved away from the float 42 in the direction indicated by arrow B. Because of the shape of the first slider 76 and the second slider 78, each of the first slider 76 and the second slider 78 can slide away from the float 42.

With reference to FIGS. 41-45, a float 42 in accordance with another aspect of the present disclosure. The structure and operation of the float 42 is substantially similar to the float 42 described above with respect to FIG. 30, except for the features described below. The first pin 50 includes a pin end portion 86 and main pin portion 88 coupled to the pin end portion. The pin end portion 86 has a cross-section with a circular shape to help locate the first pin 50 during assembly with the ribbon 46. The pin end portion 86 has a tapered shape. As such, the diameter of the pin end portion 86 continuously decreases in the first direction FD. The main pin portion 88 of the first pin 50 has a cross-section with an oval shape that matches the shape of the first slot 66 to maximize the strength of the connection between the first pin 50 and the ribbon 46. The cross-sectional area at the main pin portion 88 is greater than the cross-sectional area at the pin end portion 86 to help retain the ribbon 46 to the first pin 50. Therefore, in the depicted embodiment, the first slot 66 has an oval shape that matches the shape of the main pin portion 88 of the first pin 50. The retaining feature 48 includes a first wing 90 extending directly from the first side 51 of the first pin 50 and a second wing 92 extending directly from the second side 53 of the first pin 50. When the ribbon 46 is coupled to the float 42, the first end portion 62 of the ribbon 46 rests directly on the first wing 90 and the second wing 92 to help maintain the ribbon 46 connected to the float 42. The perimeter of the main pin portion 88 is less than the perimeter of the first slot 66 to facilitate assembly.

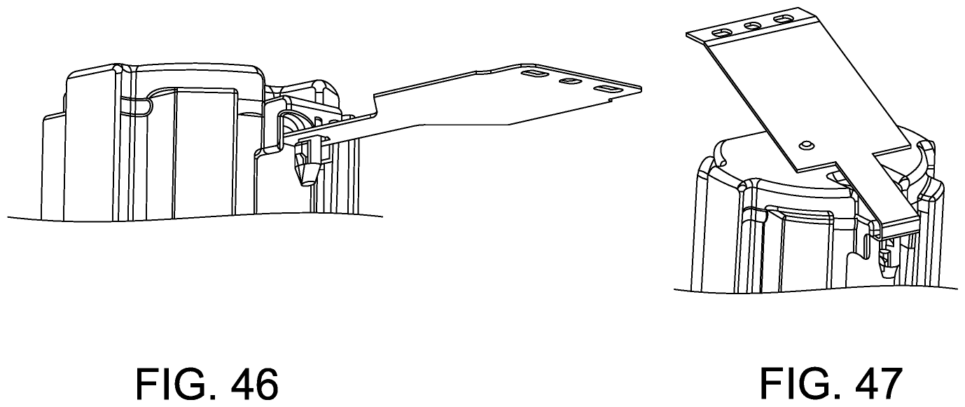

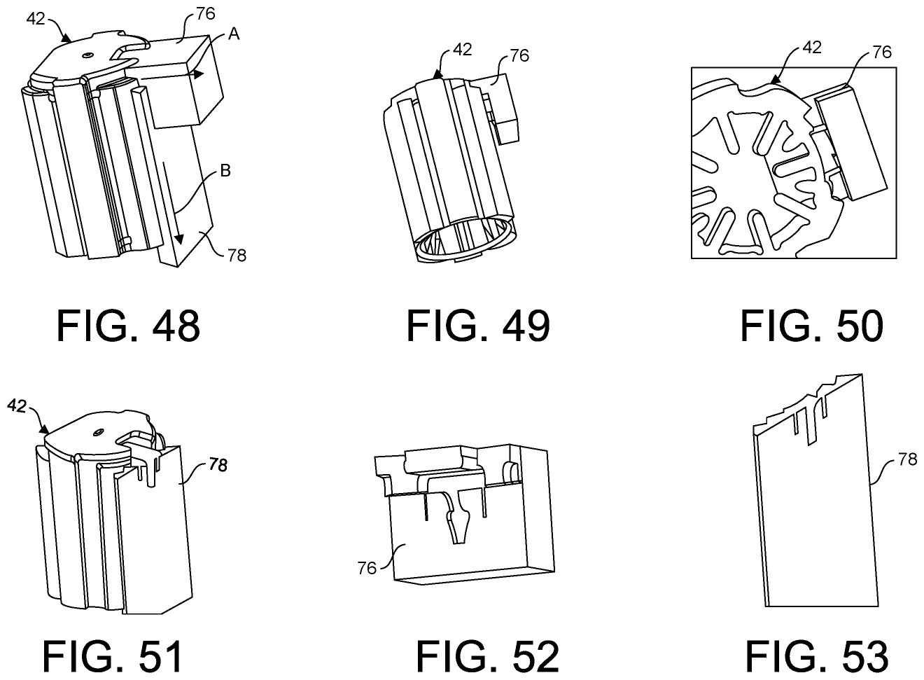

With reference to FIGS. 46 and 47, to couple the ribbon 46 to the float 42 with the first wing 90 and the second wing 92, the ribbon 46 is moved toward the float 42 so that the first pin 50 is inserted into the first slot 66. Then, the ribbon 46 is moved toward the first wing 90 and the second wing 92 until the first end portion 62 of the ribbon 46 rests on the first wing 90 and the second wing 92 as shown in FIG. 47, thereby coupling the ribbon 46 to the float 42. Next, the ribbon 46 is bent over the float 42 so that the second end portion 64 of the ribbon 46 is positioned above the float 42 as shown in FIG. 48.

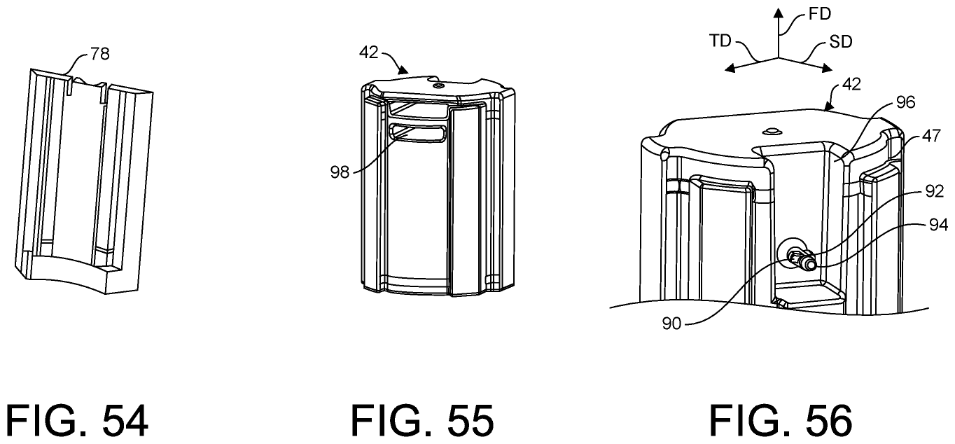

With reference to FIG. 48-54, to manufacture the float 42 depicted in FIG. 44, a first slider 76 and a second slider 78 may be used during an injection molding process. The first slider 76 is shaped to form an area of the float 42 surrounding the flange 54. Accordingly, the first slider 76 has inner cavities that correspond to the shape of the area surrounding the flange 54. The second slider 78 is shaped to form a rear area of the float 42, including the area surrounding the retaining feature 48. Therefore, the second slider 78 includes inner cavities that correspond to the shape of the rear area of the float 42, including the area surrounding the retaining feature 48. To manufacture the float 42, a polymeric material is injected into a mold. After the float 42 is formed, the first slider 76 is moved away from the float 42 in the direction indicated by arrow A, and the second slider 78 is moved away from the float 42 in the direction indicated by arrow B. Because of the shape of the first slider 76 and the second slider 78, each of the first slider 76 and the second slider 78 can slide away from the float 42.

With reference to FIGS. 55 and 56, a float 42 in accordance with another aspect of the present disclosure. The structure and operation of the float 42 is substantially similar to the float 42 described above with respect to FIG. 6. Instead of the first pin 50, the float 42 includes a second pin 94 disposed within a recess 96 defined by the main float body 47. The second pin 94 may be referred to as the horizontal pin. The second pin 94 is integrally coupled to the main float body 47. As such, the second pin 94 and the main float body 47 are part of a unitary, one-piece structure. The second pin 94 extends directly from the main float body 47 in the second direction SD. The cross-section of the second pin 94 may have a circular or oval shape. In the depicted embodiment, the first wing 90 and the second wing 92 extend directly from the second pin 94 in third direction TD to help maintain the ribbon 46 connected to the float 42. The float 42 further includes float cavities 98.

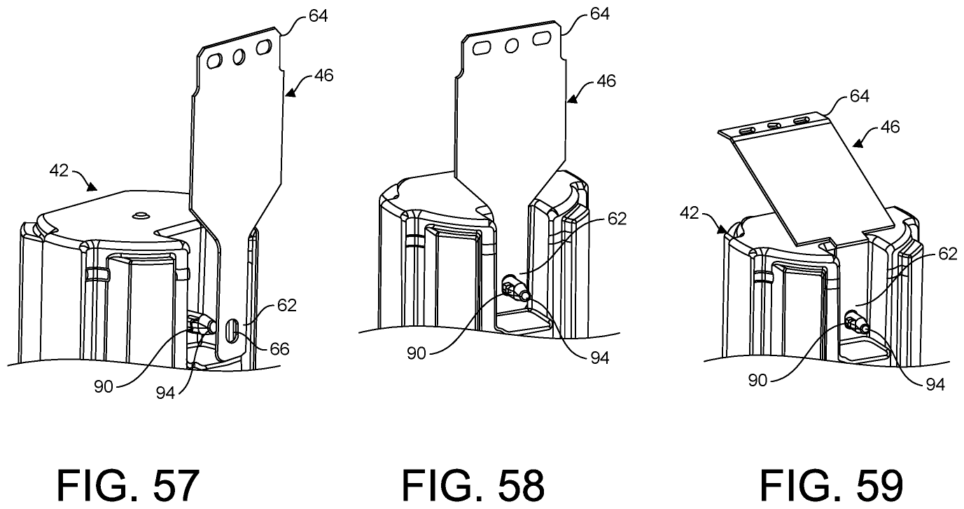

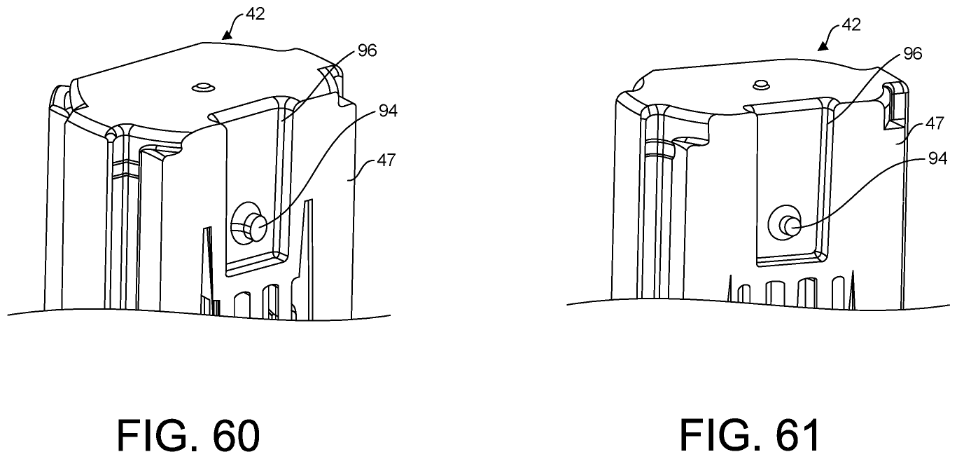

With reference to FIGS. 57, 58, and 59, to couple the ribbon 46 to the float 42 with the second pin 94 and the first wing 90 and the second wing 92, the ribbon 46 is moved toward the float 42 so that the second pin 94 is inserted into the first slot 66 as shown in FIG. 58. Then, the ribbon 46 is moved toward the first wing 90 and the second wing 92 until the first end portion 62 of the ribbon 46 is pushed pass the first wing 90 and the second wing 92 as shown in FIG. 59, thereby coupling the ribbon 46 to the float 42. Next, the ribbon 46 is bent over the float 42 so that the second end portion 64 of the ribbon 46 is positioned above the float 42 as shown in FIG. 60.

With reference to FIG. 60, a float 42 in accordance with another aspect of the present disclosure is shown. The structure and operation of the float 42 is substantially similar to the float 42 described above with respect to FIG. 57. In the depicted embodiment, the cross-section of the horizontal pin 94 has an oval shape.

With reference to FIG. 61, a float 42 in accordance with another aspect of the present disclosure is shown. The structure and operation of the float 42 is substantially similar to the float 42 described above with respect to FIG. 57. In the depicted embodiment, the cross-section of the horizontal pin 94 has a circular shape.

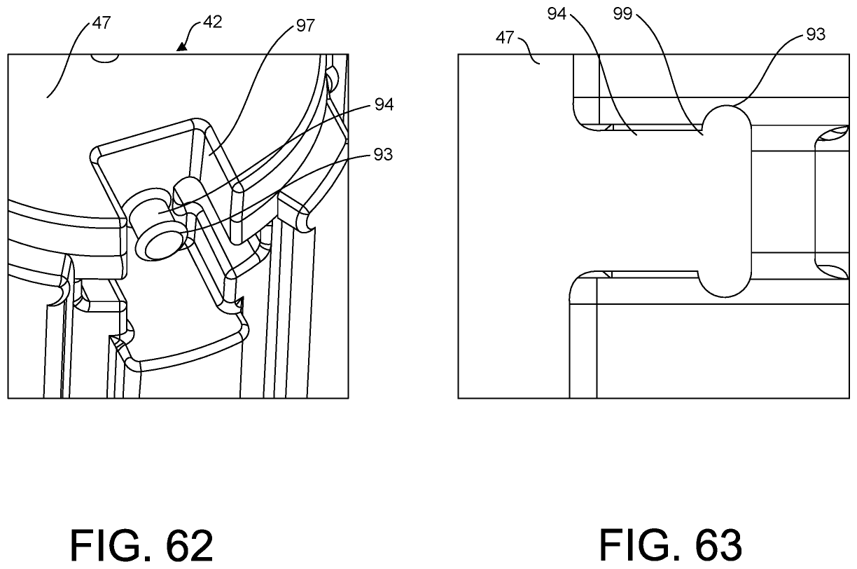

With reference to FIGS. 62 and 63, a float 42 in accordance with another aspect of the present disclosure is shown. The structure and operation of the float 42 is substantially similar to the float 42 described above with respect to FIG. 57. In the depicted embodiment, the second pin 94 is entirely disposed in a pocket 97 defined by the main float body 47 of the float 42 to protect the second pin 94. The float 42 further includes a mechanical stop 93 disposed at an end 99 of the second pin 94. The mechanical stop 93 may be configured as a rim extending radially outward at the end 99 of the second pin 94 to help retain the ribbon 46 to the float 42. In the depicted embodiment, the mechanical stop 93 has a circular shape. It is envisioned, however, that the mechanical stop 93 may have other suitable shapes, such as elliptical, oval, among others.

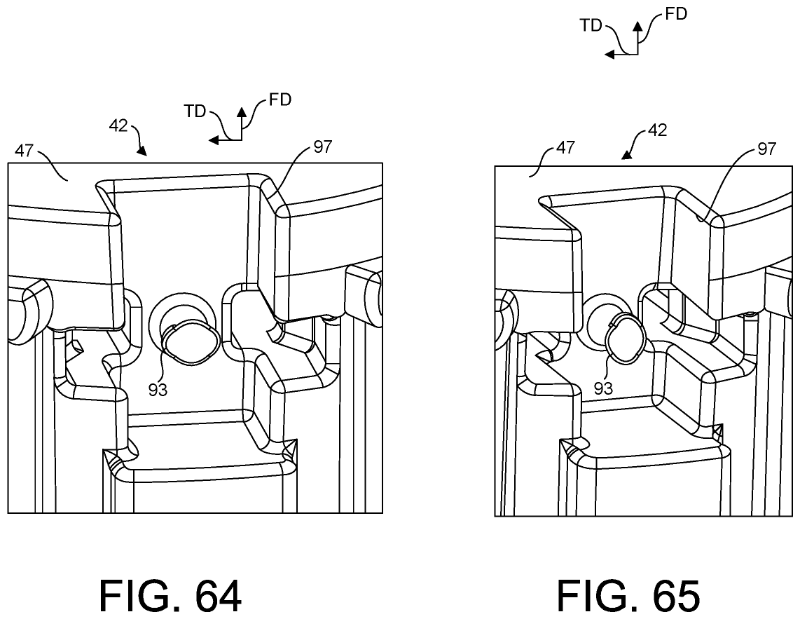

With reference to FIG. 64, a float 42 in accordance with another aspect of the present disclosure is shown. The structure and operation of the float 42 is substantially similar to the float 42 described above with respect to FIG. 61. In the depicted embodiment, the mechanical stop 93 is elongated along the third direction TD and has a quasi-oval shape.

With reference to FIG. 65, a float 42 in accordance with another aspect of the present disclosure is shown. The structure and operation of the float 42 is substantially similar to the float 42 described above with respect to FIG. 61. In the depicted embodiment, the mechanical stop 93 is elongated along the first direction FD and has a quasi-oval shape.

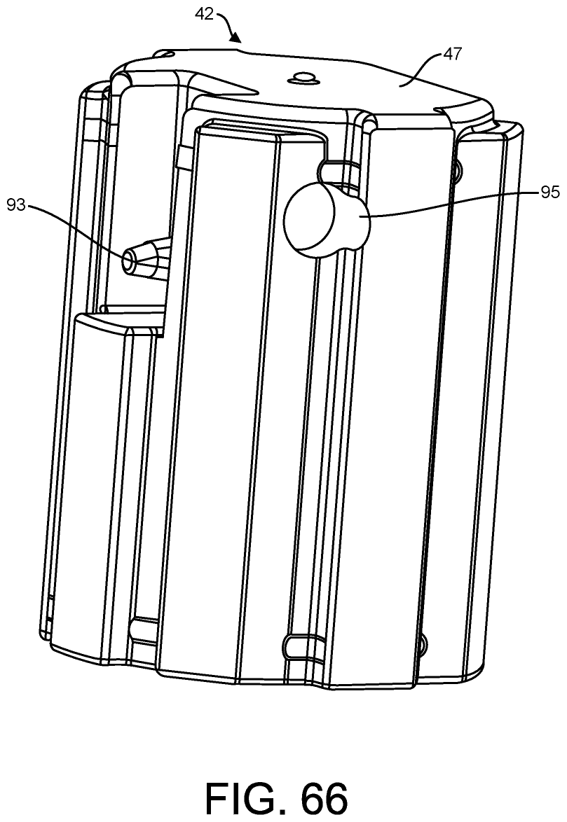

FIG. 66 shows a float 42 in accordance with another aspect of the present disclosure. The structure and operation of the float 42 is substantially similar to the float 42 described above with respect to, e.g., FIG. 61 except for the features described below. In the depicted embodiment, a hole 95 is located at the top of the float. As liquid, e.g., gas, level rises, the float rises, air escapes through the hole 95, and the float becomes capable of filling with more liquid. This decreases the buoyancy of the float 42.

While the best modes for carrying out the teachings have been described in detail, those familiar with the art to which this disclosure relates will recognize various alternative designs and embodiments for practicing the teachings within the scope of the appended claims. The valve assembly illustratively disclosed herein may be suitably practiced in the absence of any element which is not specifically disclosed herein. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings.

What is claimed is:

1. A valve assembly, comprising:
a valve housing;
a cap coupled to the valve housing and defining a cap inlet;
a float movably disposed inside the valve housing such that the float is movable relative to the valve housing, wherein movement of the float depends on an amount of fluid present in the valve housing;
a ribbon coupled between the float and the cap such that the ribbon is movable relative to the valve housing upon movement of the float, wherein the ribbon is configured to seal the cap inlet when the fluid present in the valve housing exceeds a threshold amount; and
wherein the float comprises a main float body and a retaining feature integrally coupled to the main float body, and the retaining feature secures the ribbon to the float by being inserted through a slot in the ribbon.

2. The valve assembly of claim 1, wherein:
the ribbon is movable relative to the valve housing between a first ribbon position and a second ribbon position;
the ribbon is spaced apart from the cap inlet of the cap to allow fluid flow through the cap inlet in the first ribbon position;
the ribbon seals the cap inlet of the cap to preclude fluid from exiting the valve housing through the cap in the second ribbon position;
the valve assembly is characterized by an absence of a clip coupling the ribbon to the float; and
the retaining feature is integrally coupled to the main float body such that the main float body and the retaining feature are part of a unitary one-piece structure.

3. The valve assembly of claim 2, wherein the ribbon is directly coupled to the float, and the ribbon is directly coupled to the valve housing.

4. The valve assembly of claim 1, wherein:
the float is movable relative to the valve housing along a first direction;
the retaining feature comprises a first pin that is elongated along the first direction;
the ribbon comprises a first end portion and a second end portion opposite the first end portion; and
the slot of the ribbon extends through the first end portion and receives the first pin to couple the ribbon to the float.

5. The valve assembly of claim 4, wherein the float comprises a retaining protrusion extending directly from the first pin along a second direction, the second direction is perpendicular to the first direction, and the first end portion of the ribbon rests directly on the retaining protrusion securing the ribbon coupled to the float.

6. The valve assembly of claim 5, wherein:
the float comprises a flange extending from the main float body in the second direction;
the float further comprises a first sidewall and a second sidewall each coupled to the flange;
the first sidewall, the second sidewall, and the first pin are parallel to one another;
the retaining feature further comprises a first beam extending directly from the first sidewall along a third direction, the third direction being perpendicular to the first direction and the second direction,
the retaining feature further comprises a second beam extending directly from the second sidewall in the third direction;
each of the first beam and the second beam are spaced apart from the first pin; and
the first end portion of the ribbon rests on the first beam and the second beam secures the ribbon coupled to the float.

7. The valve assembly of claim 1, wherein:
the float is movable relative to the valve housing along a first direction;
the retaining feature comprises a first pin that is elongated along the first direction;
the ribbon comprises a first end portion and a second end portion opposite the first end portion;
the slot of the ribbon extends through the first end portion and receives the first pin to couple the ribbon to the float;
the retaining feature further comprises a barb integrally coupled to the first pin such that the barb and the first pin are part of a unitary one-piece structure, wherein the barb has a tapered shape such that a width of the barb continuously increases in a second direction, the second direction being perpendicular to the first direction;
the retaining feature further comprises a first rib coupled to the main float body and a second rib coupled to the main float body, the first rib and the second rib being parallel to each other, and the first pin and the barb being disposed between the first rib and the second rib; and
the float further comprises a flange extending from the main float body, the flange being directly coupled to the first pin, and the flange being coupled between the first rib and the second rib.

8. The valve assembly of claim 1, wherein:
the float is movable relative to the valve housing along a first direction;
the retaining feature comprises a first pin that is elongated along the first direction;
the ribbon comprises a first end portion and a second end portion opposite the first end portion;
the slot of the ribbon extends through the first end portion and receives the first pin to couple the ribbon to the float;
the retaining feature further comprises a first rib coupled to the main float body and a second rib coupled to the main float body, the first rib and the second rib being parallel to each other, and the first pin being disposed between the first rib and the second rib;
the float further comprises a flange extending from the main float body in a second direction, the second direction being perpendicular to the first direction;
the flange is directly coupled to the first pin, and the flange is coupled between the first rib and the second rib;
the first pin has a first side and a second side opposite the first side;
the retaining feature further comprises a first projection extending directly from first side of the first pin along a third direction, the third direction being perpendicular to the first direction and the second direction;
the retaining feature further comprises a second projection extending directly from the second side of the first pin along the third direction;
the first projection and the second projection are disposed below the first rib and the second rib; and
the first end portion of the ribbon rests on the first projection and the second projection to secure the ribbon coupled to the float.

9. The valve assembly of claim 1, wherein:
the float is movable relative to the valve housing along a first direction;
the retaining feature comprises a first pin that is elongated along the first direction;
the ribbon comprises a first end portion and a second end portion opposite the first end portion;
the slot of the ribbon extends through the first end portion and receives the first pin to couple the ribbon to the float;
the slot has an oval shape;
the first pin has a main pin portion, the main pin portion having a cross-section with an oval shape that matches the oval shape of the slot;
the first pin has a pin end portion, the pin end portion having a tapered shape, and the pin end portion having an end cross-section with a circular shape;
the first pin has a first side and a second side opposite the first side; and
the first pin comprises a first wing extending from the first side and a second wing extending from the second side.

10. The valve assembly of claim 1, wherein:
the float is movable relative to the valve housing along a first direction;
the retaining feature comprises a second pin that is elongated along a second direction, the second direction being perpendicular to the first direction;
the ribbon comprises a first end portion and a second end portion opposite the first end portion;
the slot of the ribbon extends through the first end portion and receives the second pin to couple the ribbon to the float;
the float defines a recess;
the second pin is disposed within the recess; and
the second pin is integrally coupled to the float such that the second pin and the float are part of a unitary one-piece structure.

11. The valve assembly of claim 10, wherein the second pin has an oval shape.

12. The valve assembly of claim 10, wherein the second pin has a circular shape.

13. The valve assembly of claim 10, wherein the second pin has at least one wing to help retain the ribbon.

14. The valve assembly of claim 1, wherein:
the float is movable relative to the valve housing along a first direction;
the retaining feature comprises a second pin that is elongated along a second direction, the second direction being perpendicular to the first direction;
the ribbon comprises a first end portion and a second end portion opposite the first end portion;
the slot of the ribbon extends through the first end portion and receives the second pin to couple the ribbon to the float;
the float defines a pocket;
the second pin is entirely disposed within the pocket;
the second pin is integrally coupled to the float such the second pin and the float are part of a unitary one-piece structure; and
the second pin comprises a mechanical stop extending radially outward from an end of the second pin to retain the ribbon to the float.

15. A fuel tank assembly, comprising:
a fuel tank;
a valve assembly coupled to the fuel tank, wherein valve assembly includes:
a valve housing;
a cap coupled to the valve housing and defining a cap inlet;
a float movably disposed inside the valve housing such that the float is movable relative to the valve housing, wherein movement of the float depends on an amount of fluid present in the valve housing;
a ribbon coupled between the float and the cap such that the ribbon is movable relative to the valve housing upon movement of the float, wherein the ribbon is configured to seal the cap inlet when the fluid present in the valve housing exceeds a threshold amount; and
wherein the float includes a main float body and a retaining feature integrally coupled to the main float body, and the retaining feature secures the ribbon to the float by being inserted through a slot in the ribbon.

16. The fuel tank assembly of claim 15, wherein:
the ribbon is movable relative to the valve housing between a first ribbon position and a second ribbon position;
the ribbon is spaced apart from the cap inlet of the cap to allow fluid flow through the cap inlet in the first ribbon position;
the ribbon seals the cap inlet of the cap to preclude fluid from exiting the valve housing through the cap in the second ribbon position;
the valve assembly is characterized by an absence of a clip coupling the ribbon to the float; and
the retaining feature is integrally coupled to the main float body such that the main float body and the retaining feature are part of a unitary one-piece structure.

17. The fuel tank assembly of claim 16, wherein the ribbon is directly coupled to the float, and the ribbon is directly coupled to the valve housing.

18. The fuel tank assembly of claim 15, wherein:
the float is movable relative to the valve housing along a first direction,
the retaining feature comprises a first pin that is elongated along the first direction,
the ribbon comprises a first end portion and a second end portion opposite the first end portion,
the slot of the ribbon extends through the first end portion and receives the first pin to couple the ribbon to the float.

19. The fuel tank assembly of claim 18, wherein:
the float comprises a retaining protrusion extending directly from the first pin along a second direction, the second direction being perpendicular to the first direction; and
the first end portion of the ribbon rests directly on the retaining protrusion securing the ribbon coupled to the float.

20. A method of coupling a ribbon to a float of a valve assembly, comprising:
moving a ribbon towards a float until a slot of a first end portion of the ribbon engages a retaining feature of the float, wherein the ribbon is configured to seal a cap inlet when fluid present in a valve housing exceeds a threshold amount;
bending a second end portion of the ribbon to over the float in order to facilitate assembly with a valve housing of the valve assembly, wherein the housing assembly comprises:
a valve housing;
a cap coupled to the valve housing and defining the cap inlet; and
securing the ribbon to the float by inserting a retaining feature through a slot in the ribbon, wherein the retaining feature is coupled to a main float body, wherein the main float body is part of the float.
